(19) United States
(12) Patent Application Publication
(10) Pub. No.: US 2016/0251515 A1
(43) Pub. Date: Sep. 1, 2016

(54) CURABLE RESIN COMPOSITION, ARTICLE, AND METHOD FOR FABRICATING THE SAME

(71) Applicant: LEE CHANG YUNG CHEMICAL INDUSTRY CORPORATION, Kaohsiung City (TW)

(72) Inventors: Po-Nien TSAI, Tainan City (TW); Yu-Tien CHEN, Changhua County (TW); Ruoh-Huey UANG, Hsinchu County (TW)

(21) Appl. No.: 14/632,639

(22) Filed: Feb. 26, 2015

(51) Int. Cl. C08L 83/04; B29C 39/00; C09D 183/04

(52) U.S. Cl. CPC C08L 83/04; C09D 183/04; B29C 39/003; B29K 2083/00

(57) ABSTRACT

A curable resin composition, an article, and a method for fabricating the same are provided. The curable resin composition includes a siloxane resin and a catalyst. In particular, the catalyst includes an imidazole and an organic metal compound, and the organic metal compound includes an organic tin compound, organic zinc compound, organic nickel compound, organic cobalt compound, organic copper compound, or a combination thereof

### BACKGROUND

1. Technical Field

The disclosure relates to a curable resin composition, an article, and a method for fabricating the same, and in particular to a curable siloxane resin composition, an article, and a method for fabricating the same.

2. Description of the Related Art

Organic resin, due to its properties such as high processability, light weight, low cost, and impact resistant, has gradually replaced inorganic glass for use in optical components such as optical lenses and packaging materials for electronic components. Recently, due to the development of light-emitting diode techniques (e.g., high brightness, multicolor properties, etc.), organic siloxane resins, which have better heat resistance, water resistance, and transparency, have gradually replaced epoxy resins for use as a packaging material for electronic components.

An organic siloxane resin, i.e., organopolysiloxane, can be cured through alkylation with silicon hydrides. The cured solid product of the alkylation has a high refractive index and transmittance, and can be used as a packaging material for a light-emitting diode. The conventional curable siloxane resin compositions, however, have the disadvantages of a high curing temperature and a low thermal decomposition temperature, resulting in their being inconvenient to use.

Therefore, a novel siloxane resin composition is required to solve the aforementioned problems.

### SUMMARY

According to an embodiment of the disclosure, the disclosure provides a curable resin composition, such as a curable siloxane resin composition. The curable resin composition includes a siloxane resin and a catalyst. In particular, the catalyst includes an imidazole and an organic metal compound, and the organic metal compound includes an organic tin compound, organic zinc compound, organic nickel compound, organic cobalt compound, organic copper compound, or a combination thereof

According to another embodiment of the disclosure, the disclosure provides an article which is a reaction product of the aforementioned curable resin composition.

According to other embodiments of the disclosure, the disclosure provides a method for fabricating an article. The method includes subjecting the aforementioned curable resin composition to a thermal treatment to obtain the article.

A detailed description is given in the following embodiments with reference to the accompanying drawings.

### DETAILED DESCRIPTION

The following description is of the best-contemplated mode of carrying out the disclosure. This description is made for the purpose of illustrating the general principles of the disclosure and should not be taken in a limiting sense. The scope of the disclosure is best determined by reference to the appended claims.

The disclosure provides a curable resin composition, an article, and a method for fabricating the same. According to embodiments of the disclosure, the curable resin composition of the disclosure can be cured by subjecting the composition to a thermal treatment with a process temperature that is equal to or less than about 80° C. (such as between 25° C. and 80° C.), since the curable resin composition includes a catalyst including an imidazole and an organic metal compound in a specific weight ratio. Furthermore, the article obtained by curing the curable resin composition of the disclosure can have a high mechanical strength, high weatherability, high thermal stability, and a high thermal decomposition temperature (Td).

According to embodiments of the disclosure, the curable resin composition, such as a curable siloxane resin composition, includes a siloxane resin; and a catalyst. In particular, the catalyst can include an imidazole and an organic metal compound. According to other embodiments of the disclosure, the catalyst can essentially consist of an imidazole and an organic metal compound with a specific weight ratio in order to facilitate the ability of the curable resin composition of the disclosure to be cured by subjecting the composition to a thermal treatment with a process temperature equal to or less than about 80° C. (such as between 25° C. and 80° C.). The curable resin composition of the disclosure can optionally be colorless or colored, and can serve as an adhesive, coating, packaging, composite material, or functional film, and can be used in various optical and electronic products.

In embodiments of the disclosure, the siloxane resin can include polyalkoxysiloxane, or polyalkoxysiloxane having alkyl group, epoxy group, aminoalkyl group, acrylate group, isocyanate-alkyl group, alkyl halide group, or a combination thereof. For example, the siloxane resin of the disclosure can include a condensation reaction product of at least one siloxane compound having a structure represented by SiR¹₍₄₋ₙ₎R²ₙ, wherein R¹ is independently hydroxyl group, or C₁₋₈ alkoxy group; R² is C₁₋₈ alkyl group, C₃₋₁₂ epoxy group, C₃₋₁₂ acrylate group, C₃₋₁₂ alkylacryloxy group, C₃₋₁₂ aminoalkyl group, C₃₋₁₂ isocyanate-alkyl group, C₃₋₁₂ alkylcarboxylic acid group, C₃₋₁₂ alkyl halide group, C₃₋₁₂ mercaptoalkyl group, C₃₋₁₂ alkyl group, or C₃₋₁₂ alkenyl group; and n is 0 or an integer between 1 and 3. For example, the siloxane compound can include tetramethoxysilane, tetraethoxysilane, tetrapropoxysilane, vinyltrimethoxysilane, 3-chloropropyltriethoxysilane, phenyltriethoxysilane, phenyltrimethoxysilane, glycidoxypropoxyltrimethoxysilane, glycidoxypropyltriethoxysilane, mercaptopropyltriethoxysilane, mercaptopropyltrimethoxysilane, aminopropyltrimethoxysilane, or a combination thereof In embodiments of the disclosure, the siloxane resin can include DC-804 (silicone resins, available from Dow Corning Corp), SILRES® IC 231 (silicone resins with an alkoxy content 0-20%, available from Wacker Chemie AG), SILRES® IC 836 (silicone resins, available from Wacker Chemie AG), KBM-13 (silane, available from Shin-Etsu Chemical Co., Ltd), or a combination thereof.

The imidazole can include 2-undecylimidazole, 2-heptadecylimidazole, 2-methylimidazole, 2-ethyl-4-methylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-cyanoethyl-2-undecyl imidazolium trimeritate, 1-cyanoethyl-2-phenyl imidazolium trimeritate, 2-phenyl-4,5-dihydroxymethylimidazole, 2-phenyl-4-methyl-5-dihydroxymethylimidazole, or a combination thereof.

According to embodiments of the disclosure, the organic metal compound can include Sn, Zn, Ni, Co, Cr, and/or Cu, such as an organic tin compound, organic zinc compound, organic nickel compound, organic cobalt compound, organic chromium compound, organic copper compound, or a combination thereof. For example, the organic metal compound of the disclosure can include tin (II) 2-ethylhexanoate, tin isopropoxide, tin oxalate, zinc 2,4-pentane dionate, zinc acetate, zinc oxalate, dibutyltin diacetate, dibutyltin dilaurate, dioctyltin diacetate, zinc naphthenate, zinc carboxylate, nickel carboxylate, or a combination thereof

According to embodiments of the disclosure, for the various applications, the curable resin composition can further include a pigment, a filler (such as fused silica, glass powder, aluminum nitride, boron nitride, silicon carbide, aluminum tripolyphosphate, aluminum hydroxide, titanium oxide, aluminum oxide, barium sulfate, mica, or combinations thereof), a modifier, a thickener, a defoaming agent, a mold release agent, a stabilizer, a fire retardant agent, a surfactant (such as a cationic surfactant, anionic surfactant, or a bridging surfactant), or a combination thereof.

According to embodiments of the disclosure, the weight ratio between the catalyst and the siloxane resin can be from about 0.01 to 0.1 (such as from 0.01 to 0.05). When the amount of catalyst is too low, the curable resin composition of the disclosure would be cured at a relatively high temperature (such as a temperature higher than 100° C.). On the other hand, when the amount of catalyst is too high, the cured product of the curable resin composition of the disclosure would have disadvantages such as low thermal stability, low weatherability, and low mechanical strength. According to embodiments of the disclosure, the weight ratio between the organic metal compound and the imidazole can be from about 0.1 to 10, such as from 0.1 to 5 or from 0.1 to 3. When the amount of organic metal compound is too low, the curable resin composition of the disclosure would be cured at a relatively high temperature (such as a temperature higher than 100° C.). On the other hand, when the amount of organic metal compound is too high, the cured product of the curable resin composition of the disclosure would have disadvantages such as low thermal stability, low weatherability, and low mechanical strength.

According to embodiments of the disclosure, the disclosure also provides an article, which is a reaction product of the curable resin composition of the disclosure. The article can be a coating, a film, a solid product with a specific shape after a molding process. Furthermore, the article can be a part of an optical or electronic device. It should be noted, due to the specific catalyst and the specific weight ratio of the components, the article obtained by subjecting the curable resin composition of the disclosure to a thermal treatment can have a higher thermal decomposition temperature than about 300° C., such as between 300° C. and 480° C.

According to embodiments of the disclosure, the disclosure also provides a method for preparing the aforementioned article, and the method includes subjecting the curable resin composition of the disclosure to a thermal treatment to obtain the article. Furthermore, before subjecting the curable resin composition to the thermal treatment, the curable resin composition can be coated to form a coating or a film, or it can be delivered into a mold. In embodiments of the disclosure, the thermal treatment has a process temperature less than 80° C., such as between 25° C. and 80° C.

In an embodiments of the disclosure, when the weight ratio between the catalyst and the siloxane resin is from about 0.012 to 0.015 and the weight ratio between the organic tin compound and the imidazole is from about 0.2 to 0.5, the curable resin composition of the disclosure can be cured by subjecting the composition to a thermal treatment with a process temperature between about 25° C. and 80° C. Herein, the article obtained by subjecting the above curable resin composition to a thermal treatment can have a higher thermal decomposition temperature than about 400° C. (such as between 400° C. and 480° C.). Furthermore, the article exhibits high mechanical strength, high weatherability, high thermal stability, and high thermal decomposition temperature (Td).

The following examples are intended to illustrate the disclosure more fully without limiting the scope, since numerous modifications and variations will be apparent to those skilled in this art.

### Preparation Example 1

100 parts by weight of SILRES® IC 231 (silicone resins with an alkoxy content 0-20%, available from Wacker Chemie AG), 100 parts by weight of SILRES® IC 836 (silicone resins, available from Wacker Chemie AG), and 33 parts by weight of KBM-13 (silane, available from Shin-Etsu Chemical Co., Ltd) were added into a reaction bottle and then mixed uniformly, obtaining the siloxane resin LCY 2.

### Example 1

2 parts by weight of Tin (II) 2-ethylhexanoate (available from Alfa Aesar) and 1 part by weight of 2-ethyl-4-methylimidazole (available from T.C.I. with a trade No. of EMI-24) were added into a reaction bottle and dissolved in tetrahydrofuran (THF). Next, after stirring, 100 parts by weight of siloxane resin LCY 2 was added into the reaction bottle. After stirring, the resin composition (I) was obtained. A coating of the resin composition (I) was formed and then was subjected to a thermal treatment with a process temperature of 50° C. The coating of the resin composition (I) was completely cured within 3hr and a cured product was obtained. Next, the thermal decomposition temperature (Td) of the cured product was measured, and the result is shown in Table 1.

### Example 2

1 part by weight of Tin (II) 2-ethylhexanoate (available from Alfa Aesar) and 1 part by weight of 2-ethyl-4-methylimidazole (available from T.C.I. with a trade No. of EMI-24) were added into a reaction bottle and dissolved in tetrahydrofuran (THF). Next, after stirring, 100 parts by weight of siloxane resin LCY 2 was added into the reaction bottle. After stirring, the resin composition (II) was obtained. A coating of the resin composition (II) was formed and then was subjected to a thermal treatment with a process temperature of 50° C. The coating of the resin composition (II) was completely cured within 3hr and a cured product was obtained. Next, the thermal decomposition temperature (Td) of the cured product was measured, and the result is shown in Table 1.

### Example 3

0.25 parts by weight of Tin (II) 2-ethylhexanoate (available from Alfa Aesar) and 1 part by weight of 2-ethyl-4-methylimidazole (available from T.C.I. with a trade No. of EMI-24) were added into a reaction bottle and dissolved in tetrahydrofuran (THF). Next, after stirring, 100 parts by weight of siloxane resin LCY 2 was added into the reaction bottle. After stirring, the resin composition (III) was obtained. A coating of the resin composition (III) was formed and then was subjected to a thermal treatment with a process temperature of 50° C. The coating of the resin composition (III) was completely cured within 3 hr and a cured product was obtained. Next, the thermal decomposition temperature (Td) of the cured product was measured, and the result is shown in Table 1.

### Example 4

A coating of the resin composition (III) of Example 3 was formed and then was subjected to a thermal treatment with a process temperature of 25° C. The coating of the resin composition (III) was completely cured for 3 hr and a cured product was obtained. Next, the thermal decomposition temperature (Td) of the cured product was measured, and the result is shown in Table 1.

### Example 5

0.125 parts by weight of Tin (II) 2-ethylhexanoate (available from Alfa Aesar) and 1 part by weight of 2-ethyl-4-methylimidazole (available from T.C.I. with a trade No. of EMI-24) were added into a reaction bottle and dissolved in tetrahydrofuran (THF). Next, after stirring, 100 parts by weight of siloxane resin LCY 2 was added into the reaction bottle. After stirring, the resin composition (IV) was obtained. A coating of the resin composition (IV) was formed and then was subjected to a thermal treatment with a process temperature of 50° C. The coating of the resin composition (IV) was completely cured within 3 hr and a cured product was obtained. Next, the thermal decomposition temperature (Td) of the cured product was measured, and the result is shown in Table 1.

### Comparative Example 1

100 parts by weight of siloxane resin LCY 2 was added into the reaction bottle, and the siloxane resin was coated to form a coating. The coating was completely cured at a temperature about 270° C. for 2 hr and a cured product was obtained. Next, the thermal decomposition temperature (Td) of the cured product was measured, and the result is shown in Table 1.

### Comparative Example 2

10 parts by weight of Tin (II) 2-ethylhexanoate (available from Alfa Aesar) was added into a reaction bottle and dissolved in tetrahydrofuran (THF). Next, after stirring, 100 parts by weight of siloxane resin LCY 2 was added into the reaction bottle. After stirring, the resin composition (V) was obtained. A coating of the resin composition (V) was formed. The coating was subjected to a thermal treatment with a process temperature of 180° C. for 2 hr to be completely cured (the coating was not cured completely at a temperature less than 150° C.). Next, the thermal decomposition temperature (Td) of the cured product was measured, and the result is shown in Table 1.

### Comparative Example 3

1.5 parts by weight of 2-ethyl-4-methylimidazole (available from T.C.I. with a trade No. of EMI-24) was added into a reaction bottle and dissolved in tetrahydrofuran (THF). Next, after stirring, 100 parts by weight of siloxane resin LCY 2 was added into the reaction bottle. After stirring, the resin composition (VI) was obtained. A coating of the resin composition (VI) was formed. The coating was subjected to a thermal treatment with a process temperature of 50° C. for 24 hr, but the coating of the resin composition (VI) was not completely cured.

TABLE 1

| | | Catalyst | | | | |
|---|---|---|---|---|---|---|
| | Si- | Tin (II) | 2-ethyl- | | | |
| | loxane | 2-ethyl- | 4-methyl- | Cur- | Cur- | |
| | resin | hexanoate | imidazole | ing | ing | |
| | (parts by | (parts by | (parts by | temp | time | Td |
| | weight) | weight) | weight) | ( ) | (far) | ( ) |
| Example 1 | 100 | 2 | 1 | 50 | 3 | 340.3 |
| Example 2 | 100 | 1 | 1 | 50 | 3 | 330.2 |
| Example 3 | 100 | 0.25 | 1 | 50 | 3 | 440.1 |
| Example 4 | 100 | 0.25 | 1 | 25 | 3 | >400 |
| Example 5 | 100 | 0.125 | 1 | 50 | 3 | 310.2 |
| Compar- | 100 | 0 | 0 | 270 | 2 | 322.6 |
| ative | | | | | | |
| Example 1 | | | | | | |
| Compar- | 100 | 10 | 0 | 180 | 2 | 332.78 |
| ative | | | | | | |
| Example 2 | | | | | | |
| Compar- | 100 | 0 | 1.5 | 50 | 24 | non- |
| ative | | | | | | cured |
| Example 3 | | | | | | |

As shown in Table 1, in the absence of the organic tin compound or the imidazole, the siloxane resin is cured at a high temperature of 250° C. (Comparative Example 1). In comparison with Comparative Example 1, the resin composition of Comparative Example 2 is cured at a relatively low temperature of 180° C., but the curing temperature of the composition of Comparative Example 2 is still higher than 150° C. due to the absence of the imidazole. Furthermore, the resin composition of Comparative Example 3 cannot be cured at a 50° C. due to the absence of the organic tin compound.

Accordingly, the disclosure provides a curable resin composition, an article, and a method for fabricating the same. According to embodiments of the disclosure, the curable resin composition of the disclosure can be cured by subjecting the composition to a thermal treatment with a process temperature between about 25° C. and 80° C., since the curable resin composition includes a catalyst including an imidazole and an organic metal compound in a specific weight ratio. Furthermore, the article exhibits high mechanical strength, high weatherability, high thermal stability, and high thermal decomposition temperature (Td).

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A curable resin composition, comprising:
a siloxane resin; and
a catalyst, wherein the catalyst comprises an imidazole and an organic metal compound, and wherein the organic metal compound comprises an organic tin compound, organic zinc compound, organic nickel compound, organic cobalt compound, organic copper compound, or a combination thereof, wherein the weight ratio between the catalyst and the siloxane resin is from 1.125:100 to 10:100.

2. (canceled)

3. The curable resin composition as claimed in claim 1, wherein the weight ratio between the organic metal compound and the imidazole is from 0.1 to 10.

4. The curable resin composition as claimed in claim 1, wherein the siloxane resin comprises a polyalkoxysiloxane, or polyalkoxysiloxane having alkyl group, epoxy group, aminoalkyl group, acrylate group, isocyanate-alkyl group, alkyl halide group, or a combination thereof.

5. The curable resin composition as claimed in claim 1, wherein the imidazole comprises 2-undecylimidazole, 2-heptadecylimidazole, 2-methylimidazole, 2-ethyl-4-methylimidazole, 2-phenylimidazole, 2-phenyl-4-methylimidazole, 1-benzyl-2-methylimidazole, 1-benzyl-2-phenylimidazole, 1,2-dimethylimidazole, 1-cyanoethyl-2-methylimidazole, 1 -cyanoethyl-2-ethyl-4-methylimidazole, 1-cyanoethyl-2-undecylimidazole, 1-cyanoethyl-2-phenylimidazole, 1-cyanoethyl-2-undecyl imidazolium trimeritate, 1-cyanoethyl-2-phenyl imidazolium trimeritate, 2-phenyl-4,5-dihydroxymethylimidazole, 2-phenyl-4-methyl-5-dihydroxymethylimidazole, or a combination thereof.

6. The curable resin composition as claimed in claim 1, wherein the organic metal compound comprises tin (II) 2-ethylhexanoate, tin isopropoxide, tin oxalate, zinc 2,4-pentane dionate, zinc acetate, zinc oxalate, dibutyltin diacetate, dibutyltin dilaurate, dioctyltin diacetate, zinc naphthenate, zinc carboxylate, nickel carboxylate, or a combination thereof.

7. The curable resin composition as claimed in claim 1, wherein the curable resin composition further comprises a pigment, filler, modifier, thickener, defoaming agent, mold release agent, stabilizer, fire retardant agent, surfactant, or a combination thereof.

8. An article, which is a reaction product of the composition as claimed in claim 1.

9. The article as claimed in claim 8, wherein the article has a thermal decomposition temperature more than 300° C.

10. A method for fabricating an article, comprising:
subjecting the curable resin composition as claimed in claim 1 to a thermal treatment to obtain the article.

11. The method as claimed in claim 10, before subjecting the curable resin composition to the thermal treatment, further comprising:
forming a coating or a film of the curable resin composition.

12. The method as claimed in claim 10, before subjecting the curable resin composition to the thermal treatment, further comprising:
delivering the curable resin composition into a mold.

13. The method as claimed in claim 10, wherein the thermal treatment has a higher process temperature than 25° C.

14. The method as claimed in claim 10, wherein the thermal treatment has a process temperature between 25° C. and 80° C.

15. The curable resin composition as claimed in claim 1, wherein the catalyst reacts with the siloxane resin so as to form the curable resin composition.
